(19) United States
(12) Patent Application Publication
(10) Pub. No.: US 2007/0259156 A1
(43) Pub. Date: Nov. 8, 2007

(54) Hydrophobic surfaces and fabrication process

(75) Inventors: Roger S. Kempers, Dublin (IE); Alan D. O'Loughlin, Glasnevin (IE); Alan M. Lyons, Malahide (IE)

Correspondence Address: THE ECLIPSE GROUP, 10605 BALBOA BLVD., SUITE 300, GRANADA HILLS, CA, 91344, US

(73) Assignee: Lucent Technologies, Inc., Murray Hill, NJ (US)

(21) Appl. No.: 11/416,893

(22) Filed: May 3, 2006

(51) Int. Cl. B32B 3/20; G09G 5/00

(52) U.S. Cl. 428/188; 345/6

(57) ABSTRACT

Apparatus including: a conduit body having a lining that bounds a channel having a longitudinal axis; the lining including a lining base; the lining including raised micro-scale features monolithic with the lining base. Apparatus including: a cavity body at least partially enclosing a cavity; the cavity having a lining that bounds a channel having a longitudinal axis; the lining including a lining base; the lining including raised micro-scale features monolithic with the lining base. Process including: providing a three-dimensional graphics design for a device having a superhydrophobic pattern of raised micro-scale features on a base, the base and the raised micro-scale features being monolithic; inputting the three-dimensional graphics design to a three-dimensional rapid prototype fabrication apparatus; and laying down build material and monolithically fabricating the base and the raised micro-scale features. Further process in which the three-dimensional graphics design is input as a negative image to the three-dimensional rapid prototype fabrication apparatus, and the base and the raised micro-scale features are monolithically fabricated by laying down support material.

### BACKGROUND OF THE INVENTION

1. Field of the Invention

This invention relates generally to structures having superhydrophobic surfaces, and processes for their fabrication.

2. Related Art

Hydrophobic structures are known for their ability to repel high surface tension liquids such as water. Some hydrophobic structures have been made that include a plurality of raised features that are spaced apart by interstices and held in positions relative to each other on a substrate. These raised features may take the form of various shapes, including posts, blades, spikes, and ridges. When a liquid having a sufficiently high surface tension makes contact with such a hydrophobic structure, the liquid may form an interface with the hydrophobic structure at a local contact angle sufficiently high so that the liquid does not immediately penetrate into the interstices. Such a structure is then described as being “superhydrophobic”.

Common fabrication processes for superhydrophobic structures include nanolithography, nano-embossing, and deposition of superhydrophobic coatings from solution. Nanolithography processes may include etching posts, blades, spikes, ridges or other raised features into a surface of a ceramic body such as a silicon wafer, followed by applying a hydrophobic coating onto the raised features. These processes are typically limited to formation of the raised features on a substantially planar substrate, and adhesion of the hydrophobic coatings onto the raised features, as well as uniform wetting of the ceramic by such coatings, are unreliable. Nano-embossing may include pressing a superhydrophobic structure into a deformable surface such as a wax sheet to form molds for raised features, removing the structure from the deformable surface, molding a curable composition into the molds and onto the deformable surface, and peeling the cured composition away from the deformable surface. Such molding processes typically yield some acceptable superhydrophobic structures and a significant proportion of defective structures having unacceptable quality. Deposition of superhydrophobic coatings onto a support from solution typically results in the same problems with regard to wetting uniformity and adhesion as earlier discussed. In all of these conventional techniques, moreover, the resulting superhydrophobic structures typically include an array of raised features spaced apart on a substantially planar substrate. Hence, in addition to the quality and yield issues generated by such techniques for fabricating superhydrophobic structures, these processes also constrain the potential designs for such structures. Deposition of superhydrophobic coatings from solution may, in addition, require the preparation of complex coating compositions including nanoparticles, a binder, and a dispersing agent. Such coating compositions may be suitable for deposition onto a non-planar surface, but superhydrophobic surfaces prepared by this technique also typically suffer from the adhesion and yield issues previously discussed. In addition, adjustment of the geometry of superhydrophobic nanotextured surfaces so prepared in order to control or change the flow or superhydrophobic properties of the surfaces may not be feasible.

There accordingly is a continuing need for new types of superhydrophobic structures that make feasible the exploitation of superhydrophobic surface behavior, as well as a continuing need for new processes facilitating the fabrication of such new types of superhydrophobic structures.

### SUMMARY

In an implementation example, an apparatus is provided, including: a conduit body having a lining that bounds a channel having a longitudinal axis; the lining including a lining base; the lining including raised micro-scale features monolithic with the lining base.

As another example of an implementation, an apparatus is provided, including: a cavity body at least partially enclosing a cavity; the cavity having a lining that bounds a channel having a longitudinal axis; the lining including a lining base; the lining including raised micro-scale features monolithic with the lining base.

In another example, a process is provided, including: providing a three-dimensional graphics design for a device having a superhydrophobic pattern of raised micro-scale features on a base, the base and the raised micro-scale features being monolithic; inputting the three-dimensional graphics design to a three-dimensional rapid prototype fabrication apparatus; and laying down build material and monolithically fabricating the base and the raised micro-scale features.

As an additional implementation a process is provided, including: providing a three-dimensional graphics design for a device having a superhydrophobic pattern of raised micro-scale features on a base, the base and the raised micro-scale features being monolithic; inputting the three-dimensional graphics design as a negative image to a three-dimensional rapid prototype fabrication apparatus; and laying down support material and monolithically fabricating the base and the raised micro-scale features.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a perspective view showing an implementation of an example of an apparatus including: a conduit body having a lining that bounds a channel having a longitudinal axis; the lining including a lining base; the lining including raised micro-scale features monolithic with the lining base.

FIG. 2 is a top view, taken on line 2-2, of the conduit shown in FIG. 1.

FIG. 3 is a perspective view showing an example implementation of an apparatus including: a cavity body at least partially enclosing a cavity; the cavity having a lining that bounds a channel having a longitudinal axis; the lining including a lining base; the lining including raised micro-scale features monolithic with the lining base.

FIG. 4 is a top view, taken on line 4-4, of the cavity shown in FIG. 3.

FIG. 5 is a cross-sectional view, taken on line 5-5, of the cavity shown in FIG. 3.

FIG. 6 is a flow-chart showing an example of an implementation of a process for fabricating a device having a superhydrophobic pattern of raised micro-scale features on a base, the base and the raised micro-scale features being monolithic.

FIG. 7 is a perspective view showing an implementation of an example of a conduit including a conduit body having a lining that bounds a channel having a longitudinal axis; the lining including a lining base; the lining including raised micro-scale features monolithic with the lining base, during fabrication according to a process of FIG. 6.

### DETAILED DESCRIPTION

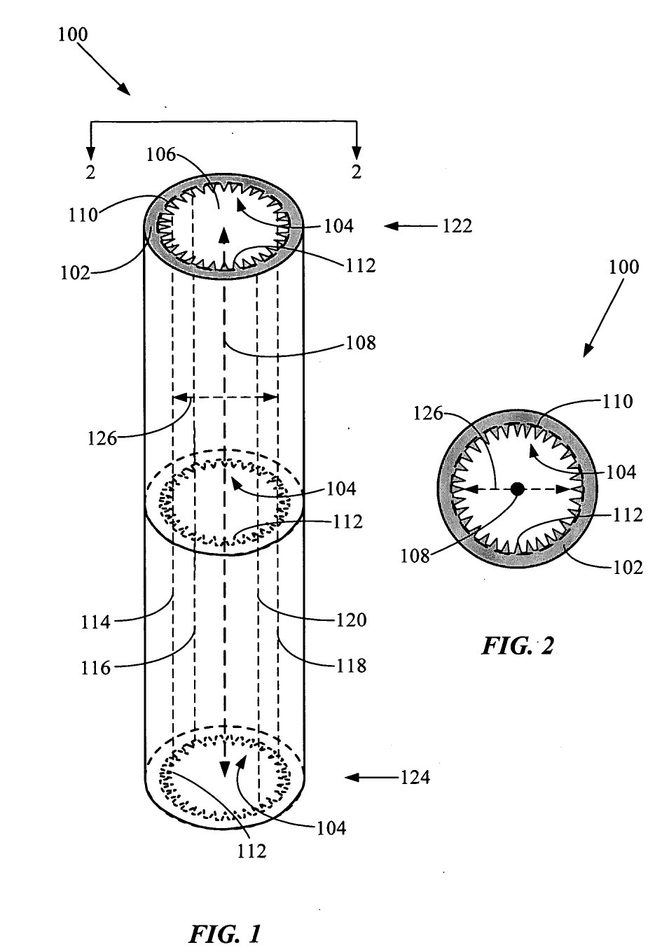

FIG. 1 is a perspective view showing an implementation of an example of a conduit 100, including: a conduit body 102 having a lining 104 that bounds a channel 106 having a longitudinal axis 108; the lining including a lining base 110; the lining including raised micro-scale features 112 monolithic with the lining base.

Throughout this specification, the term “conduit” means an interior region of a structure that is capable of conveying a fluid from one point to another. Throughout this specification, the term “lining” means a covering on an inside surface of a conduit or cavity.

The average diameter of the raised micro-scale features 112 measured at their lining bases 110 is less than about 1,000 micrometers (referred to throughout this specification as “micro-scale”). As an example, the average diameter of the raised micro-scale features 112 measured at their lining bases 110 may be less than about 400 micrometers. In an implementation, the average diameter of the raised micro-scale features 112 measured at their lining bases 110 may be greater than about 50 micrometers. Raised micro-scale features 112 having relatively small average diameters may generate relatively low resistance to flow of a fluid over the raised micro-scale features.

In an implementation, the average length of the raised micro-scale features 112 may be less than about 10 millimeters (“mm”) on and extending away from their lining bases 110. In a further example, the average length of the raised micro-scale features 112 may be less than about 2 mm on and extending away from their lining bases 110. As an additional implementation, the average length of the raised micro-scale features 112 may be greater than about 10 mm on and extending away from their lining bases 110. In another example, the average length of the raised micro-scale features 112 may be greater than about 16 micrometers, on and extending away from their lining bases 110. As another implementation, the average length of the raised micro-scale features 112 may be within a range of between about 1,000 micrometers and about 2,000 micrometers on and extending away from their lining bases 110.

The lining 104 includes the lining base 110, schematically indicated by a dotted line, and the raised micro-scale features 112 which extend from the lining base in directions generally toward the longitudinal axis 108. Throughout this specification, the term “lining base” means a region of the inside surface of a conduit or cavity underlying a region of raised micro-scale features, the raised micro-scale features being adjacent an interior channel within the conduit or cavity. The lining base includes a layer of material constituting a part of the lining of a conduit or cavity. The lining 104, including the raised micro-scale features 112 and the lining base 110, is monolithic. Throughout this specification, the term “monolithic” means that the device elements so described, such as the raised micro-scale features 112 and the lining base 110, are a single, unitary body of the same material. Boundaries of the lining 104 bounding the channel 106 are schematically defined by example dotted lines 114, 116, 118 and 120. Ends 122, 124 of the conduit 100 facilitate passage of a fluid (not shown) through the conduit 100 generally in the directions of the arrows at the ends of the longitudinal axis 108. The conduit 100 includes the conduit body 102. As an example, the conduit body 102 and the lining 104 may be monolithic. In another implementation, the longitudinal axis 108 may include a curved region (not shown), and the lining 104 may generally follow the curve. As examples, the curve may be gradual or may include an abrupt bend. The longitudinal axis 108 may also include a straight region, or the entire longitudinal axis may be curved. The channel 106 has a diameter 126 represented by a dotted line with arrows and defined in a direction transverse to the longitudinal axis 108. In an implementation, the conduit body 102 may have a generally cylindrical outer shape, so that the conduit 100 has the overall shape of a pipe. As another example (not shown) the conduit body 102 may include additional material, such that the conduit 100 has another selected outer shape. In a further implementation (not shown) the conduit 100 may be integrated into a device having further components.

FIG. 2 is a top view, taken on line 2-2, of the conduit 100 shown in FIG. 1. FIG. 1 shows that the diameter 126 of the channel 106 may be uniform along the longitudinal axis 108 of the conduit 100. As another example (not shown), the diameter 126 of the channel 106 may include two different values at different positions along the longitudinal axis 108. In an implementation (not shown), values for the diameter 126 may define a grade or another variation pattern in one or both directions along the longitudinal axis, forming a funnel or pipette tip as examples.

In an implementation, the lining base 110 may be substantially covered by a superhydrophobic pattern of raised micro-scale features 112. By “substantially covered” is meant that the raised micro-scale-features 112 are spaced apart on the lining base 110 with sufficient density so that the lining 104 exhibits superhydrophobic behavior. The term “superhydrophobic” as used throughout this specification means that the subject superhydrophobic pattern of raised micro-scale features is not immediately wetted by a liquid having a surface tension greater than about 70 dynes per centimeter (“d/cm”), and may not be immediately wetted by a liquid having a surface tension greater than about 28 d/cm. As an example, an alcohol having a surface tension of about 28 d/cm may not immediately wet a superhydrophobic pattern of raised micro-scale features as disclosed in this specification.

As an example, the raised micro-scale features 112 may be arranged in a pattern on the lining base 110 so that an average spacing (“pitch”) between nearest adjacent raised micro-scale features 112 is within a range of between about 1 micrometer and about 1 mm. In another implementation, the raised micro-scale features 112 may be arranged in a pattern on the lining base 110 so that an average pitch between nearest adjacent raised micro-scale features 112 is within a range of between about 0.2 mm and about 0.6 mm. In a further implementation, the raised micro-scale features 112 may be randomly spaced apart, uniformly spaced apart, or spaced apart in a defined pattern or gradient on the lining base 110.

The raised micro-scale features 112 may have any selected cross-sectional shape or shapes, such a cross-section being defined as a section through a raised micro-scale feature in a direction generally transverse to a portion of the lining base 110 from which the raised micro-scale feature extends toward the longitudinal axis 108. As examples, such cross-sectional shapes may include, singly or in combination, posts, blades, spikes, pyramids, square rectangles, nails, and ridges. Suitable cross-sectional shapes are shown, as examples, in FIGS. 1A-E and 3A-C of U.S. patent application Ser. No. 10/806,543, entitled “Dynamically Controllable Biological/Chemical Detectors Having Nanostructured Surfaces”, issued on ______ as U.S. Pat. No. ______, the entirety of which is hereby incorporated herein by reference. Further suitable cross-sectional shapes are disclosed in U.S. patent application Ser. No. 11/387,518, entitled “Super-Phobic Surface Structures”, filed on Mar. 23, 2006, the entirety of which is hereby incorporated herein by reference.

In addition to forming a superhydrophobic pattern, the raised micro-scale features 112 may also collectively function as a thermal insulator. In an implementation, the raised micro-scale features 112 may have cross-sectional shapes that vary in size along the lengths of the raised micro-scale features. As an example, such variable cross-sectional shapes may define void space between adjacent raised micro-scale features. This void space may increase the effectiveness of the superhydrophobic pattern of raised micro-scale features 112 to function as a thermal insulator.

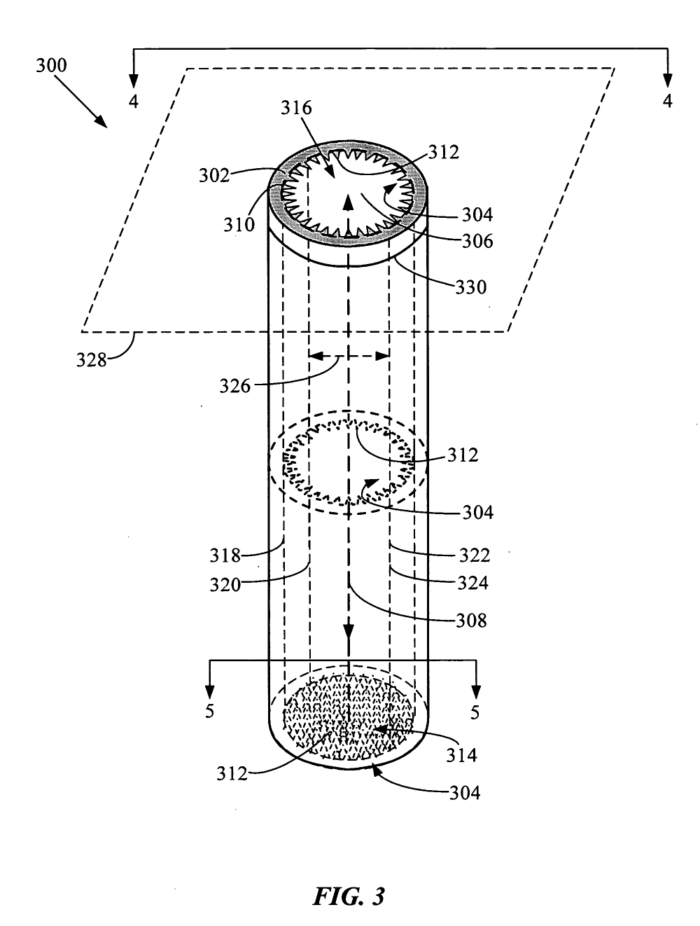

In an implementation, the raised micro-scale features 112 may have square pyramid shapes with average square dimensions of about 200 micrometers×200 micrometers measured at the lining base 110, the raised micro-scale features 112 being on and extending away from the lining base 110 by an average length of about 2000 micrometers, at a pitch of about 200 micrometers. In another implementation, the raised micro-scale features 112 may have square rectangle shapes with average dimensions of about 200 micrometers×200 micrometers measured at the lining base 110, the raised micro-scale features 112 being on and extending away from the lining base 110 by an average length of about 1500 micrometers, at a pitch of about 600 micrometers. As a further example, the raised micro-scale features 112 may have square rectangle shapes with average dimensions of about 200 micrometers×200 micrometers measured at the lining base 110, the raised micro-scale features 112 being on and extending away from the lining base 110 by an average length of about 1000 micrometers, at a pitch of about 600 micrometers. In an additional implementation, the raised micro-scale features 112 may have square rectangle shapes with average dimensions of about 200 micrometers×200 micrometers measured at the lining base 110, the raised micro-scale features 112 being on and extending away from the lining base 110 by an average length of about 1500 micrometers, at a pitch of about 500 micrometers. As a further example, the raised micro-scale features 112 may have square rectangle shapes with average dimensions of about 200 micrometers×200 micrometers measured at the lining base 110, the raised micro-scale features 112 being on and extending away from the lining base 110 by an average length of about 1000 micrometers, at a pitch of about 500 micrometers. In another implementation, the raised micro-scale features 112 may have square rectangle shapes with average dimensions of about 200 micrometers×200 micrometers measured at the lining base 110, the raised micro-scale features 112 being on and extending away from the lining base 110 by an average length of about 1000 micrometers, at a pitch of about 400 micrometers. As a further example, the raised micro-scale features 112 may have nail shapes with average dimensions of about 100 micrometers×200 micrometers measured at the lining base 110, the raised micro-scale features 112 being on and extending away from the lining base 110 by an average length of about 1000 micrometers, at a pitch of about 400 micrometers. These same examples of dimensions and pitches for the raised micro-features 112 may also be utilized in forming raised micro-scale features 312 as discussed below in connection with FIGS. 3-5.

Materials for forming the lining 104 of the conduit 100 may include precursor reagents yielding a selected polymer suitable for forming a mechanically strong solid body. In an implementation, precursors for a polymer material may be selected depending in part upon the relative flexibility or rigidity of the resulting polymer. As examples, the conduit 100 may include rigid or flexible polymers depending upon a selected end-use application for the conduit 100. In another implementation, precursors for a biocompatible polymer may be selected. As an example, polyethylene is biocompatible. In the case of rapid prototype laydown processes (discussed below) employing materials applied in a solid state, polymer particles having a narrow particle size distribution may as an example be selected. In another example, polymer particles may be selected having a relatively small average particle size, so that raised micro-scale features having relatively small dimensions may be fabricated. Where an ink-jet process or other fluid spraying process is selected for lay-down of material forming the lining 104, as discussed further below, the reagents may be provided in a fluid form such as a liquid.

Materials for forming the lining 104 of the conduit 100 may include monomers, oligomers, pre-polymers and polymers, as well as curing agents and other polymerization additives. Suitable polymers to be used or formed may include: polyolefins such as polyethylene, polypropylene and copolymers; acrylic polymers; acrylonitrile-butadiene-styrene (“ABS”) polymers; polycarbonates (“PC”); PC-ABS; methyl methacrylates; methyl methacrylate—ABS copolymers (“ABSi”); polyphenylsulfones; polyamides; and fluoropolymers such as fluorinated ethylene propylene copolymers and Teflon® fluorinated hydrocarbon polymers. As an example, a polymer having a minimal concentration of active hydrophilic moieties may be selected. Additives may be selected to increase the overall flexibility of the lining 104. In an example, molecules that are compatible with a selected polymer but having relatively low molecular weights may be used as flexibilizing additives. For polyethylene polymers, low molecular weight linear hydrocarbon waxes, as an implementation, may be used as flexibilizing additives. In another example, halogenated hydrocarbons, such as perfluorinated hydrocarbon waxes, may be used as such additives. In another implementation, ultraviolet-cured polymers such as acrylic, urethane acrylate, vinyl ether, epoxy acrylate, epoxy and vinyl chloride polymers may be used. Suitable polymer compositions may include rapid prototyping polymers commercially available from Stratasys Inc., 14950 Martin Dr., Eden Prairie, Minnesota 55344, and from Redeye RPM, 8081 Wallace Rd., Eden Prairie, Minnesota 55344. In an implementation, the same materials used for forming the lining 104 may be used for forming the conduit body 102.

FIG. 3 is a perspective view showing an example implementation of a cavity 300 including: a cavity body 302 at least partially enclosing the cavity; the cavity having a lining 304 that bounds a channel 306 having a longitudinal axis 308; the lining including a lining base 310; the lining including raised micro-scale features 312 monolithic with the lining base. The lining 304 includes raised micro-scale features 312.

The average diameter of the raised micro-scale features 312 measured at their lining bases 310 is less than about 1,000 micrometers. As an example, the average diameter of the raised micro-scale features 312 measured at their lining bases 310 may be less than about 400 micrometers. In an implementation, the average diameter of the raised micro-scale features 312 measured at their lining bases 310 may be greater than about 50 micrometers.

In an implementation, the average length of the raised micro-scale features 312 may be less than about 10 mm on and extending away from their lining bases 310. In a further example, the average length of the raised micro-scale features 312 may be less than about 2 mm on and extending away from their lining bases 310. As an additional implementation, the average length of the raised micro-scale features 312 may be greater than about 10 mm on and extending away from their lining bases 310. In another example, the average length of the raised micro-scale features 312 may be greater than about 16 micrometers on and extending away from their lining bases 310. As another implementation, the average length of the raised micro-scale features 312 may be within a range of between about 1,000 micrometers and about 2,000 micrometers on and extending away from their lining bases 310.

The lining 304 includes the lining base 310, schematically indicated by a dotted line, from which the raised micro-scale features 312 extend in directions generally toward the longitudinal axis 308. Raised micro-scale features 312 also extend from the floor 314 of the lining 304 in directions generally toward an open end 316 of the cavity 300. The lining 304, including both the lining base 310 and the raised micro-scale features 312, is monolithic. Boundaries of the lining 304 bounding the channel 306 are schematically defined by example dotted lines 318, 320, 322 and 324. The open end 316 of the cavity 300 facilitates passage of a fluid (not shown) into and out of the cavity 300 generally in the directions of the arrows on the longitudinal axis 308. The cavity 300 includes the cavity body 302. As an example, the cavity body 302, and the lining 304 including both the lining base 310 and the raised micro-scale features 312, may be monolithic.

As an example (not shown), such a lining 304 may have an overall hemispherical shape with an axis projecting orthogonally from a plane of the cavity opening to the perimeter of the hemisphere. In another implementation, the longitudinal axis 308 may include a curved region (not shown), and the lining 304 may generally follow the resulting curve. As examples, the curve may be gradual or may include an abrupt bend. The longitudinal axis 308 may also include a straight region, or the entire longitudinal axis may be curved. The channel 306 has a diameter 326 represented by a dotted line with arrows and defined in a direction transverse to the longitudinal axis 308. The diameter 326 of the channel 306 may be uniform along the longitudinal axis 308 of the cavity 300. As another example (not shown), the diameter 326 of the channel 306 may include two different values at different positions along the longitudinal axis 308. In an implementation (not shown), values for the diameter 326 may define a grade or another variation pattern in one or both directions along the longitudinal axis, forming a flask or bowl as examples.

In an implementation, the lining base 310 may be substantially covered by a superhydrophobic pattern of raised micro-scale features 312. By “substantially covered” is meant that the raised micro-scale-features 312 are spaced apart on the lining base 310 with sufficient density so that the lining 304 exhibits superhydrophobic behavior.

As an example, the raised micro-scale features 312 may be arranged in a pattern on the lining base 310 so that an average pitch between nearest adjacent raised micro-scale features 312 is within a range of between about 1 micrometer and about 1 mm. In another implementation, the raised micro-scale features 312 may be arranged in a pattern on the lining base 310 so that an average pitch between nearest adjacent raised micro-scale features 312 is within a range of between about 0.2 mm and about 0.6 mm. In a further implementation, the raised micro-scale features 312 may be randomly spaced apart, uniformly spaced apart, or spaced apart in a defined pattern or gradient on the lining base 310.

As an example, the cavity 300 may be incorporated into a larger device (not shown) so that the cavity body 302 is integrated with additional material (not shown). In an implementation, a plurality of cavities 300 may have their longitudinal axes 308 aligned in a mutually parallel spaced apart array, each cavity 300 having an open end 316, the open ends aligned in a plane 328. The plane 328 may, as an example, intersect the cavity body 302 along a circular wall 330. As an example, ninety-six cavities 300 may collectively form a standard 96-well micro-well plate for utilization in carrying out biological and chemical tests. In an implementation, the raised micro-scale features 312 may facilitate self-cleaning of reagents from the cavities 300 after completion of aqueous phase tests.

The raised micro-scale features 312 may have any selected cross-sectional shape or shapes in the same manner as discussed earlier in connection with FIG. 1, such a cross-section being defined as a section through an example raised micro-scale feature 312 taken in a direction generally transverse to a portion of the lining base 310 from which the raised micro-scale feature extends toward the longitudinal axis 308. In addition to forming a superhydrophobic pattern, the raised micro-scale features 312 may also collectively function as a thermal insulator. In an implementation, the raised micro-scale features 312 may have cross-sectional shapes that vary in size along the lengths of the raised micro-scale features. As an example, such variable cross-sectional shapes may define void space between adjacent raised micro-scale features. This void space may increase the effectiveness of the superhydrophobic pattern of raised micro-scale features 312 to function as a thermal insulator.

The same materials as discussed above for forming the lining 104 of FIG. 1 are used for forming the lining 304. In an implementation, the same materials may also be used for forming the cavity body 302.

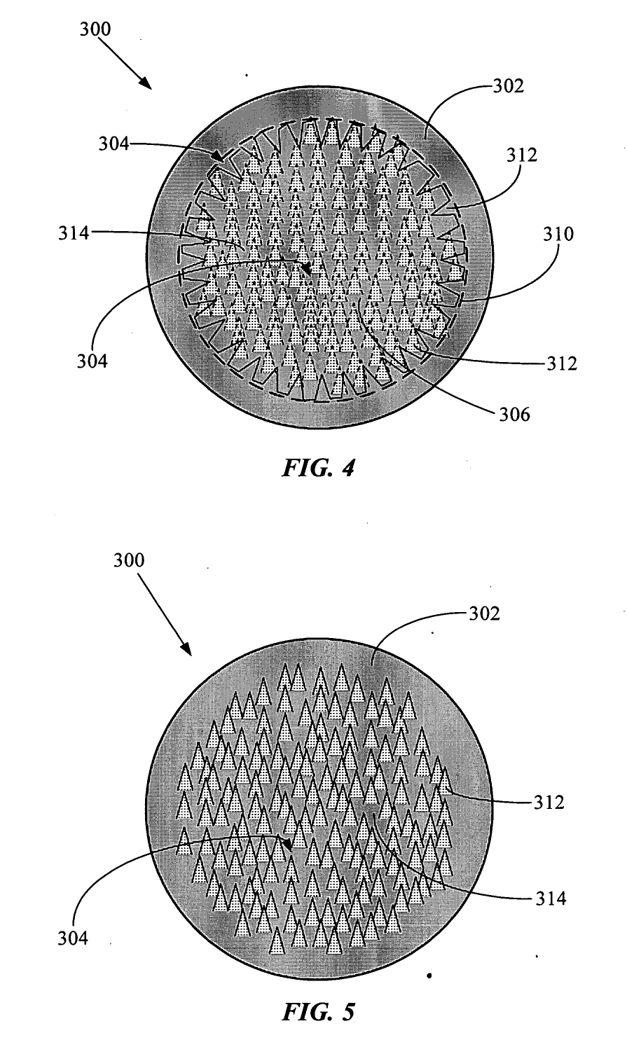

FIG. 4 is a top view, taken on line 4-4, of the cavity 300 shown in FIG. 3. FIG. 4 shows various orientations of raised micro-scale features 312 on the lining base 310. FIG. 5 is a cross-sectional view, taken on line 5-5, of the floor 314 of the cavity 300 shown in FIG. 3. FIG. 5 shows an array of raised micro-scale features 312 on a part of the lining base 310 forming the floor 314 of the lining 304. The raised micro-scale features 312 on the floor 314 of the lining 304 are shown in FIGS. 4 and 5 as raised profiles, although in an actual view on line 4-4 or line 5-5 many of them would be seen top-down as dots.

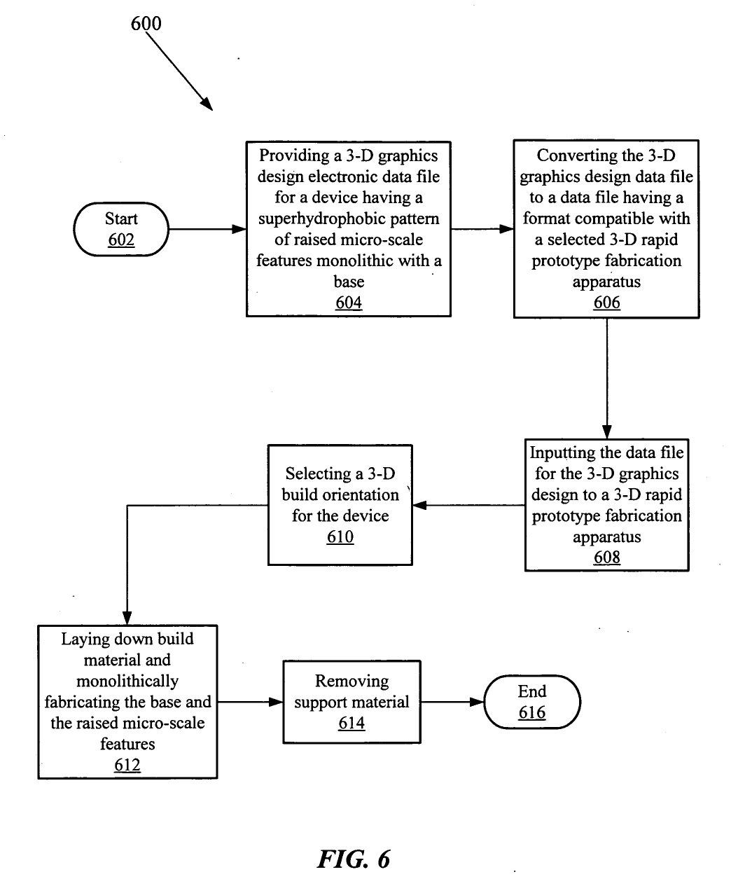

FIG. 6 is a flow-chart showing an example of an implementation of a process 600 for fabricating a device having a superhydrophobic pattern of raised micro-scale features on a base, the base and the raised micro-scale features being monolithic. The process starts at step 602, and at step 604 a three-dimensional (“3-D”) graphics design electronic data file is provided for a device having a superhydrophobic pattern of raised micro-scale features monolithic with a base. In an implementation, the process 600 is utilized to fabricate a conduit 100 as discussed above in connection with FIGS. 1 and 2. The 3-D graphics design may be created using a 3-D graphics computer program, also known as computer-aided-design (“CAD”). As examples, the 3 ds Max surface modeling program commercially available from Autodesk, Inc., 111 McInnis Parkway, San Rafael, Calif. 94903 may be utilized. In another implementation, the PRO/Engineer solid modeling program commercially available from Parametric Technology Corporation, 140 Kendrick St., Needham, Mass. 02494 may be utilized.

At step 606, the 3-D graphics design data file may be converted to an electronic data file having a format that is compatible with a selected 3-D rapid prototype fabrication (“RPF”) apparatus. At step 608, the 3-D graphics data file is input to a selected 3-D rapid prototype fabrication apparatus.

In an implementation, the 3-D rapid prototype fabrication apparatus may then be used to convert the 3-D graphics data file into a conduit 100 by successively laying down layers of a build material for the conduit, including material for monolithically fabricating the lining base 110 and the raised micro-scale features 112.

Among examples of laydown processes carried out by commercially-available RPF apparatus that may be selected for utilization to fabricate the conduit 100 by the process 600 are the following: thermal phase change ink jet deposition, photopolymer phase change ink jet deposition, stereolithography (“SLA”), solid ground curing (“SGC”), selective laser sintering (“SLS”), fused deposition modeling (“FDM”), laminated object manufacturing (“LOM”), and 3-D printing (“3DP”). Each of these processes may involve the successive laydown of thin layers of build material for the conduit 100 on a support surface. The support surface may be a solid platform or a liquid surface on which the build material is caused to float. In the event that build material needs to be laid down at a location spaced apart above the support surface, then a support material on which the spaced apart build material can subsequently be deposited is laid down when and where needed for that purpose, arranged for its subsequent removal. As examples, the support material may be wax that can be removed by heat, or a material that can be selectively dissolved.

Each of these processes lays down build material in either liquid or solid form. Processes involving laydown of build material in a liquid form include thermal phase change ink jet, photopolymer phase change ink jet, and SLA processes. Utilization of the ink jet processes may result in fabrication of relatively high quality conduits 100, as solidification of the liquid build material sprayed from the ink jets may occur with minimal void formation. Moreover, the liquid build material sprayed from the ink jets may have a very small particle size, such a particle size permitting fabrication of raised micro-scale features having relatively small dimensions. Minimum feasible dimensions for the raised micro-scale features may, however, be limited by flow dynamics of the liquid build material in the ink jet system. Thermal phase change ink jet apparatus may employ limited types of build materials compatible with the ink jets and suitable for solidification on cooling, which may yield relatively tough but brittle conduits 100. Photopolymer phase change ink jet apparatus may employ broader classes of build materials compatible with the ink jets and suitable for curing upon exposure to ultraviolet light, which may yield either rigid or relatively flexible conduits 100. In an implementation, an InVision HR 3-D Printer commercially available from 3D-Systems, Inc., 26081 Avenue Hall, Valencia, Calif. 91355 may be utilized; and an initial 3-D graphics electronic data file may be converted into an STL file format at step 606. As an example, VisiJet® HR-200 Plastic Material, commercially available from 3-D Systems, Inc., may be utilized as the build material. VisiJet® HR-200 Plastic Material includes triethylene glycol dimethacrylate ester, urethane acrylate polymer, and propylene glycol monomethacrylate. SLA may employ a liquid photopolymer, over a vat of which an ultraviolet light laser may be traced, the solidified layers of liquid photopolymer being lowered into the vat. SGC may employ similar techniques, but the solidified layers are supported on a solid build platform.

Processes involving laydown of build material in a solid form include SLS, FDM, LOM and 3DP. SLS may employ a leveling roller that moves back and forth over two build material powder magazines, and a laser that selectively sinters build material layers from powder coatings applied by the roller onto a build platform. A 3DP process may employ a bed of build material powder, onto which an adhesive is selectively sprayed by an ink jet to form successive layers of bound build material. The 3DP process may yield conduits 100 having a relatively coarse, porous structure as a result of uneven wetting of the powder by the adhesive, and the presence of voids between bound build material particles. Excessive application of the adhesive may result in fabrication of relatively or excessively large raised micro-scale features. In an example, a build material powder having a narrow particle size distribution and very small particles may be selected. As another implementation, packing uniformity of the powder before adhesive application may be carefully controlled. As an example, a build material powder having an average particle size at least about ten times smaller than an average size of adhesive droplets sprayed by the ink jets may be selected. Such a build material powder may result in less shrinkage of the conduit 100 as it is built, than may otherwise result when utilizing ink jet printing of a liquid build material. An FDM process may employ melting and ink jet spraying of a plastic wire. A LOM process may involve successive laser cutting and bonding of thin layers of a sheet of build material.

As a further example, a 3-D rapid prototype fabrication apparatus may be programmed with a negative image of the conduit 100 so that support material is laid down instead of build material to fabricate the conduit 100. In an implementation, VisiJet® S-100 Model Material, a hydroxylated wax composition commercially available from 3-D Systems, Inc., may be utilized as the support material.

At step 610, a 3-D build orientation for the conduit 100 may be selected. As an example, referring to FIG. 1, the conduit 100 may be built either in the direction of the longitudinal axis 108 or in a transverse direction parallel to the diameter 126 of the channel 106. In an implementation, a build orientation for the conduit 100 may be selected so that raised micro-scale features 112 are built in a direction such that a need for deposition of support material is minimized or eliminated during their fabrication. As an example, fabrication of the conduit 100 in the direction of the longitudinal axis 108 using SLA may only require a minimal laydown of support material. In another implementation where the raised micro-scale features 112 are in the form of continuous ridges, fabrication of the conduit 100 in the direction of the longitudinal axis 108 using SLA, FDM, LOM, 3DP, or an InVision jet printer may not require laydown of any support material.

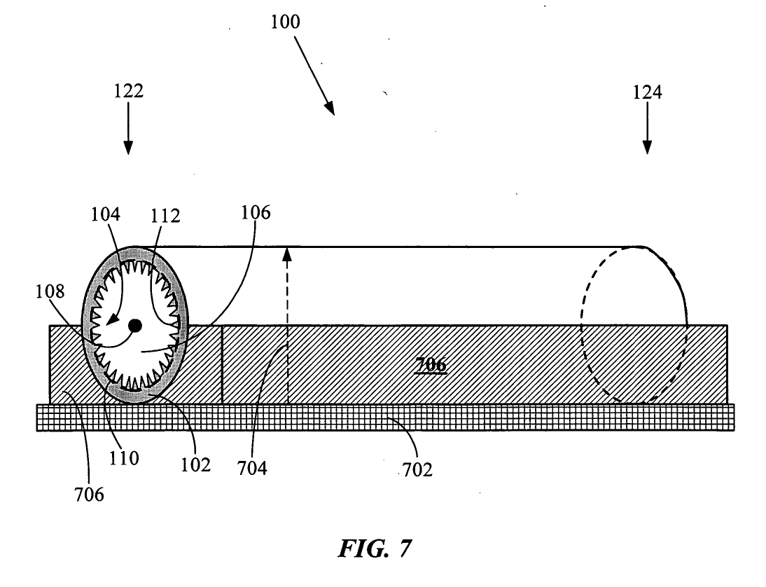

FIG. 7 is a perspective view showing an implementation of an example of a conduit 100 including a conduit body 102 having a lining 104 that bounds a channel 106 having a longitudinal axis 108; the lining including a lining base 110; the lining including raised micro-scale features 112 monolithic with the lining base, during fabrication according to a process of FIG. 6. The conduit 100 is fabricated on a build support 702 in the direction of the arrow 704. Support material 706 is laid down on the build support 702 underneath the conduit 100 as it is built. In general, if raised micro-scale features 112 are built beginning with their tips and ending with formation of the lining base 110 holding them together, then the entire void space between the raised micro-scale features may need to be filled with support material during laydown of the build material.

At step 612, build material is laid down on a build support, and the base and the raised micro-scale features are monolithically fabricated. As an example, the conduit 100 may accordingly be fabricated as shown in FIG. 7. In an implementation, each cycle of laydown of a layer of the build material may include milling of the layer to maintain level deposition of build material in the direction of the arrow 704. In this manner, precise build dimensions of the resulting conduit 100 may be controlled. As an example, the raised micro-scale features 112 may be fabricated from a flexible material so that milling results in clean abrasion of the currently-deposited layer of build material, rather than breakage of the raised micro-scale features. In an implementation, ink jet nozzles, if employed by the 3-D rapid prototype fabrication apparatus, may be tested after each laydown cycle to detect and remove any jet nozzle clogs.

Where, as in FIG. 7, support material is laid down in order to provide mechanical support for the conduit 100 during the fabrication, the support material may subsequently be removed at step 614. As examples, a support material composition may be selected such that the support material may be selectively removed by application of heat or by selective dissolution of the support material in a suitable solvent. As an example, the support material may be a wax. The process 600 then ends at step 616.

Referring to FIG. 7, it is understood that the laydown step 612 may be terminated prior to complete formation of the conduit 100. The resulting device then includes raised micro-scale features on a non-planar lining base 110.

The process 600 may also be utilized in a similar manner to fabricate the cavity 300 shown in FIG. 3. In an implementation, at step 610 a 3-D build orientation may be selected so that the raised micro-scale features 312 are fabricated first on the floor 314 of the lining 304 and then on the remainder of the lining, in a general direction toward the open end 316.

The conduits 100 and the cavities 300 may be utilized in a broad range of end-use applications where a conduit or cavity having a lining including a superhydrophobic pattern of raised micro-scale features monolithic with a lining base may be useful. As an example, the conduit 100 may facilitate ultra low-friction fluid flows. Devices containing micro-channels, such as biochips and microreactors, may be fabricated by the process 600 and may incorporate such conduits. In an implementation, the cavities 300 may serve as temporary containers for biological and chemical reagents, or as reaction vessels, and may be self-cleaning where the reagents are in the form of aqueous solutions. Raised micro-scale features may also be monolithically fabricated together with other configurations of planar or non-planar bases.

While the foregoing description refers in some instances to conduits and cavities as shown in FIGS. 1-7 having superhydrophobic patterns of raised micro-features monolithic with a lining base, it is appreciated that the subject matter is not limited to these structures nor to the structures shown in the figures. Other shapes and configurations of conduits and cavities and other devices are included, having raised micro-features that are monolithic with a base defining an interior space, and which may be superhydrophobic. Likewise, the disclosed process may be utilized to fabricate additional superhydrophobic patterns of raised micro-features that are monolithic with a base.

Moreover, it will be understood that the foregoing description of numerous implementations has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. An apparatus, comprising:
a conduit body having a lining that bounds a channel having a longitudinal axis;
the lining including a lining base;
the lining including raised micro-scale features monolithic with the lining base.

2. The apparatus of claim J, in which the conduit body is monolithic with the lining.

3. The apparatus of claim 1, in which the lining base is substantially covered by a superhydrophobic pattern of raised micro-scale features.

4. The apparatus of claim 1, including polymeric raised micro-scale features.

5. The apparatus of claim 1 in which the longitudinal axis includes a curved region.

6. The apparatus of claim 1 in which the channel has a diameter defined in a direction transverse to the longitudinal axis, and the diameter includes two different values at different positions along the longitudinal axis.

7. The apparatus of claim 1, including raised micro-scale features on and extending away from the lining base by an average length within a range of between about 1,000 micrometers and about 2,000 micrometers.

8. An apparatus, comprising:
a cavity body at least partially enclosing a cavity;
the cavity having a lining that bounds a channel having a longitudinal axis;
the lining including a lining base;
the lining including raised micro-scale features monolithic with the lining base.

9. The apparatus of claim 8 in which the cavity body is monolithic with the lining.

10. The apparatus of claim 8, in which the lining base is substantially covered by a superhydrophobic pattern of raised micro-scale features.

11. The apparatus of claim 8, including polymeric raised micro-scale features.

12. The apparatus of claim 8 in which the longitudinal axis includes a curved region.

13. The apparatus of claim 8 in which the channel has a diameter defined in a direction transverse to the longitudinal axis, and the diameter includes two different values at different positions along the longitudinal axis.

14. The apparatus of claim 8, including raised micro-scale features on and extending away from the lining base by an average length within a range of between about 1,000 micrometers and about 2,000 micrometers.

15. The apparatus of claim 8, including a plurality of cavities having their longitudinal axes aligned in a mutually parallel spaced apart array, each cavity having an open end, the open ends aligned in a plane.

16. A process, comprising:
providing a three-dimensional graphics design for a device having a superhydrophobic pattern of raised micro-scale features on a base, the base and the raised micro-scale features being monolithic;
inputting the three-dimensional graphics design to a three-dimensional rapid prototype fabrication apparatus; and
laying down build material and monolithically fabricating the base and the raised micro-scale features.

17. The process of claim 16, including providing a three-dimensional graphics design for a device including a non-planar surface, the surface including a superhydrophobic pattern of raised micro-scale features.

18. The process of claim 16, including providing a three-dimensional graphics design for a device having a superhydrophobic pattern of raised micro-scale features forming an interior region of the device.

19. The process of claim 16, in which the base is substantially covered by a superhydrophobic pattern of raised micro-scale features.

20. The process of claim 16, including forming a superhydrophobic pattern of raised micro-scale features on and extending away from the surface by an average length within a range of between about 1,000 micrometers and about 2,000 micrometers.

21. A process, comprising:
providing a three-dimensional graphics design for a device having a superhydrophobic pattern of raised micro-scale features on a base, the base and the raised micro-scale features being monolithic;
inputting the three-dimensional graphics design as a negative image to a three-dimensional rapid prototype fabrication apparatus; and
laying down support material, and monolithically fabricating the base and the raised micro-scale features.

22. The process of claim 21, including providing a three-dimensional graphics design for a device including a non-planar surface, the surface including a superhydrophobic pattern of raised micro-scale features.

23. The process of claim 21, including providing a three-dimensional graphics design for a device having a superhydrophobic pattern of raised micro-scale features forming an interior region of the device.

24. The process of claim 21, in which the base is substantially covered by a superhydrophobic pattern of raised micro-scale features.

25. The process of claim 21, including forming a superhydrophobic pattern of raised micro-scale features on and extending away from the surface by an average length within a range of between about 1,000 micrometers and about 2,000 micrometers.
